(19) United States
(12) Patent Application Publication
(10) Pub. No.: US 2021/0006423 A1
(43) Pub. Date: Jan. 7, 2021

(54) System for a Three Way Coordination of a Video Conference

(71) Applicant: Holly Gieseke, Folsom, CA (US)

(72) Inventor: Holly Gieseke, Folsom, CA (US)

(21) Appl. No.: 16/504,281

(22) Filed: Jul. 7, 2019

(51) Int. Cl. H04L 12/18; H04N 7/15

(52) U.S. Cl. CPC H04L 12/1818; H04L 12/1822; H04N 7/152

(57) ABSTRACT

The System for Three Way Coordination of a Video Conference is the ability for a remote Family member to schedule an appointment for a Student trained in Social Media and Telecommunication tools to facilitate a video conference call with the Family member from their Senior's location. The system has the ability to match the Family date/time request with a Student and an tablet date/time availability within a local range of the Senior location, describe the social media and phone number needed for the successful video call, monitor successful completion of the appointment and charge the Family credit card for the Product they ordered upon successful completion of the appointment. The Family and Student have the ability to rate each other's performance on the appointment. This system has the ability to perform a three-way match and notify each party of the confirmation and completion or cancellation of the appointment.

### CROSS-REFERENCE TO RELATED APPLICATIONS

This application claims the benefit of the U.S. Provisional Patent Application No. 62/696,638 filed Jul. 11, 2018. The entire contents of which are incorporated by reference herein.

### BACKGROUND OF THE INVENTION

The field of telecommunications encompasses many different systems for communication between individuals. Some systems involve voice communication (e.g. telephone), other systems involved text communication (e.g. email) and other systems involve video, typically also with an audio complement (e.g. video conferencing). Still other telecommunications systems involved hybrids of these systems or still other systems. The primary benefit of such telecommunications systems is that they facilitate communication between two parties which are not in the same location. In prior times communication between individuals in distant locations generally required the transportation of physical objects there between (e.g. letters, packages, messengers, etc.), with electronic telecommunication the passage of physical objects for communication has been replaced with radio waves, electrons, photons and other media being transported, often at the speed of light, for essentially simultaneous and instantaneous communication. Such modern telecommunications systems allow for a real-time communication experience which is essentially the same as when two (or more) individuals are in the same location.

While a multitude of tools and enhancements to telecommunications systems have been developed since the advent of telecommunications with the telegraph and telephone technology, some forms of communication are still difficult to effectively achieve with existing technology. One area where effective communication hurdles remain is when one of the individuals to be involved in a communications session is a Senior citizen, or disabled individual with physical and/or cognitive abilities matching that of a Senior (and hereafter referenced as a “Senior” for convenience in referencing all such individuals).

Seniors have telecommunications utilization skills which fall upon a continuum from highly skilled to completely unskilled. Often physical and/or mental impairments can cause a Senior who used to have a higher level of telecommunication skills to regress to a status where the Senior individual may have lost some skills which the Senior individual once had. In other instances, the Senior individual may never have mastered certain telecommunications abilities. These telecommunications abilities can include details such as how to dial a telephone, how to utilize a tablet device to initiate or accept a video conference call (e.g. FaceTime, Skype, etc.), adjust volume on a tablet device, avoid pushing “the wrong buttons” and inadvertently re-tasking the tablet device to doing something else besides the video conference, failure to monitor battery life on the tablet device (or other smart device, such as a smartphone) and a variety of other skills which can meaningfully enhance, or merely facilitate an effective video conference. Seniors often have sight and/or hearing impairment as well, making telecommunications sessions less effective in many instances, unless such deficiencies are effectively addressed.

Because of these problems that often exist associated with deficiencies in the skill level of Senior individuals in utilizing telecommunications equipment, a need exists for a remedy. This problem is particularly acute when a Senior individual is in a care facility or otherwise located some distance away from Family members or other individuals who have a need (or desire) to communicate with the Senior individual (e.g. medical care providers, friends, etc.). Attempts to solve this problem have included simpler and simpler telecommunications devices, in an attempt to facilitate a video conference or other telecommunications session between a Senior individual and other individuals at remote locations. While some such tools may be effective in many instances, the large continuum of Senior individual skill levels dictates that many Senior individuals will not have the skills to use even the simplest of telecommunications tools. Furthermore, for many Senior individuals, interacting with a piece of technology is not the same as interacting with a human individual. It has been discovered by the inventors of the technology described herein, that if a Senior individual receives a visit from a real person, and a video conference is simultaneously initiated between the Senior individual and other individuals at a remote location, a more effective telecommunication session and associated communication can better be achieved.

For instance, a Senior individual may have difficulty in hearing, and this problem can be difficult to diagnose and address by an individual at a remote location involved in a telecommunication session. In contrast, if an individual, referred to as a facilitator) is present visiting the Senior individual, this present facilitator individual can facilitate the telecommunication session such as by suggesting to the Senior individual that hearing aids be amplified or put into use, and to make other concrete suggestions such as holding a telecommunications tablet at an angle which decreases glare, adjusting buttons to increase contrast on the screen, turn up the volume on a tablet telecommunications device, or to repeat things that are said when such a facilitator present with the Senior individual cannot hear what was said, by recognizing that the message from a remote individual was not understood, and provide some degree of trouble shooting or “interpretation.”

Accordingly, a need exists for telecommunications systems which facilitate coordination between three individuals including an individual such as a Senior individual who has limited telecommunications tool usage skills, an individual at a remote location from the Senior individual, and a facilitator individual who is skilled in utilizing telecommunications tools the facilitator can conveniently travel to the location of the Senior individual for a telecommunications session between the Senior individual and the individual at the remote location. A high quality telecommunications session thus results, between the Senior individual and the remote individual.

### BRIEF SUMMARY OF THE INVENTION

With this invention, a principal feature is the recognition that coordination of a three way appointment between three different individuals can provide a highly successful telecommunication session between a Senior individual or similar individual with limited telecommunications tool utilization skills, and an individual who would like to communicate with the Senior individual but is at a remote location. A facilitator individual is included in the system of this invention, who can conveniently travel to the location of the Senior individual, which facilitator individual is skilled and trained in the use of various telecommunications tools, such as smartphones, tablets, etc. To coordinate these three individuals, a system is provided for effectuating a three way match between these three individuals. For maximum effectiveness, one embodiment of this invention involves programming a software application to facilitate this three way match. This software application could run on different platforms, with a primary platform for this “app” being upon a smartphone, smart tablet, or other smart device, and typically also upon a personal computer.

Further details of the system of this invention are described as features of the “app” but should be recognized as features which could be embedded within or incorporated into the system in other ways than being programmed into a smartphone app. Furthermore, skilled software programmers can implement different aspects of this system utilizing various different actual coding methodologies, languages, formats, and other details, with the elements of this invention embodied within the functional features which are achieved, rather than the actual coding which a programmer might utilize to implement features of this system.

Users of this app would fall into multiple different groups. Some users would be remote individuals, such as Family members who desire to communicate with a Senior individual at a remote location. Numerous such remote individuals would have the ability through this app to download the app onto their smart device, computer or otherwise access the system, identify information about Senior individuals (this term encompassing anyone who needs assistance with a telecommunications session, and not necessarily merely individuals of advanced age). Such information can include where the Senior individual is located, a name of the Senior individual, and if the Senior individual is at a care facility, the name of the care facility, room number, and other pertinent information about the Senior individual or the location of the Senior individual.

A separate user interface in the same app (or potentially a separate app) would typically also be provided for the facilitator individuals. Facilitator individuals would access the app or otherwise access the system and provide information about the location of the facilitator individual and the number of telecommunications skills/competencies which have been mastered by the individual, and other details such as details by which payment can be transferred to the facilitator individual as compensation for facilitating a telecommunications session according to the app of this invention and the system of this invention.

An administrator of the system would also have access to the various items of information contained within the app, for monitoring and administration purposes, such as those detailed elsewhere herein. Other groups which might have access to this system might include care facility operator personnel, who might wish to facilitate telecommunication sessions with Family members for the benefit of their patients/residents. Such an administrator might have the ability for instance to change a room number for the Senior individual within the system and might have other criteria that they could enter and modify within the system, such as preferred hours for visitation, or uploading information such as when the individual might already be scheduled for other activities and so is not an ideal time for a telecommunication session.

Another major aspect of the system/app is the maintenance of a master calendar which can have telecommunications sessions scheduled thereon and a methodology for filling the calendar with such telecommunication sessions. As one example, a remote individual might request a telecommunications session with a Senior individual. The remote individual might first propose three dates and times, along with uploading the name of the Senior individual. These “requests” would be entered into the system and then might be communicated to facilitator individuals who are within proximity to the Senior individual, or might be selected based on other criteria. Such other criteria might include the remote individual requesting a particular facilitator with which the remote individual has previously had a successful experience, or has a pre-existing comfort level.

The facilitator individual might, through the app or otherwise, block out times where the facilitator individual is not available. As an example, facilitator individuals might in many cases be students who have a class schedule but otherwise have a highly flexible schedule. The student could enter into the calendar when the student is actually in class, with other times outside of class being generally available for facilitating telecommunication sessions. Many students frequently utilize modern telecommunications tools, and so are already highly skilled in the operation of telecommunication tools which are required to be an effective facilitator of a telecommunications session between a Senior individual and a remote individual.

The system could make a “match” between the different dates and times proposed by the remote individual, with a facilitator individual who is available during one (or more) of those times and closest to the Senior individual. As one option, multiple close matches could be returned to the remote individual, and allow the remote individual to pick from a list of facilitator individuals. The facilitator individual would receive a notice of the request for telecommunication session and then would have an opportunity to accept the telecommunications session. An appointment would then be made with that facilitator and remote individual, and also with the Senior and/or a care facility where the Senior resides. Thereafter, and as the date for the appointment is approaching, the app can perform tasks such as sending out reminders. These reminders can include making sure that the telecommunications tool has been charged and is ready for use, and to ensure that the facility where the Senior individual is located has been appropriately notified (if necessary) of the upcoming visit by the facilitator individual to facilitate the telecommunication session, and to generally ensure that everyone involved can effectively perform so that a highly effective telecommunication session results.

As one aspect of this system, the facilitator would already have a smart tablet or other video conferencing telecommunications tool and would utilize the tablet or other telecommunications tool as part of the facilitating duties. In another embodiment, a Senior care facility may have multiple (or at least one) tablets which can be checked out by facilitator individuals upon their arrival at the facility. In another embodiment, an operator of the app might own and provide the smart tablets or other telecommunications tools to the facilitators. Facilitators might provide their own travel (to the Senior's location at the time of the session), or travel might also be coordinated through the system/app such as by interfacing with a ride share service (e.g. Uber, Lyft, etc.).

In addition to the three way matching of facilitators, Senior individuals (and facilities) and remote individuals, and coordination of establishment of an appointment therebetween, most preferably the system and app would also perform functions during at least part of the telecommunication session. While in one embodiment the entire telecommunication session could be provided by an operator of the system/app, such as a system that is equivalent to that of “FaceTime” or “Skype” or some other video conferencing technology, in other embodiments the app would run simultaneous with a third-party telecommunications application software device, such as those identified above.

As an example, the app/system could operate with a timer which would appear during the telecommunication session or at least different points during the telecommunication session, such as to show to all participants how much time is remaining in the session. As the session is approaching a pre-designated ending point, such notifications might become more and more prominent, so that necessary “goodbyes” and other final communications can still be fit into the session and the session can effectively end on time. The app could also have methodologies by which all participants could indicate to the system/app whether they are available for an extension of time for the session, and if everyone is agreeable, to have the telecommunication session extended.

Other features of such a system/app which might be utilized during a telecommunication session might include the ability to essentially lock the tablet or other telecommunications tool so that only limited and complex “touches” or button selection options can alter the tablet into a mode other than the telecommunications mode. In this way, a Senior individual inadvertently pushing a button will not cause the telecommunication session to fail. Further aspects of the system and app are disclosed in an included spreadsheet figure and outline document (in an Appendix), which list features that the system/app could have in various different embodiments.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When embodiments are referred to as “exemplary” or “preferred” this term is meant to indicate one example of the invention, and does not exclude other possible embodiments. When structures are identified as a means to perform a function, the identification is intended to include all structures which can perform the function specified.

### BRIEF DESCRIPTION OF DRAWINGS

FIG. 1A-L. Entity Relationship Diagram shows the relationships of entity sets stored in the database. An entity in this context is an object, a component of data. An entity set is a collection of similar entities. These entities have attributes that define its properties.

FIG. 2. Overall System shows the high-level structure of the system.

FIG. 3. Registration shows the flow of data as the user registers in the system.

FIG. 4. Login to the system shows the flow of data as the user logs into the system.

FIG. 5. Create an appointment shows the flow of data as an appointment is being created.

FIG. 6. User searching for a student shows the flow of data as a user is searching for an available student to fulfill the appointment.

FIG. 7. Appointment cancellation shows the flow of data when an appointment is canceled.

FIG. 8. Student checking whether to take appointment shows the flow of data when a Student checks to see if they wish to take an appointment.

### DETAILED DESCRIPTION OF INVENTION

The various embodiments and variations thereof illustrated in the accompanying Figures, and/or described herein are merely exemplary and are not meant to limit the scope of the invention. It is to be appreciated that numerous variations of the invention have been contemplated as would be obvious to one of ordinary skill in the art with the benefit of this disclosure. Rather, the scope and breadth afforded this document should only be limited by the claims provided here while applying either the plain meaning to each of the terms and phrases in the claims or the meaning clearly and unambiguously provided in the specification.

Terminology

Location—Address of the Senior Community where the Senior resides and the Student arrives to facilitate the telecommunication session appointment for the Senior and the Family.

Senior—Resident of the Senior Community and eldest Family member of the Family.

Family—Entity that is remote and uses the system to request and pay for an appointment, participate remotely on the telecommunication session and is related to the Senior.

Student—Employee of the business, user of the system to check and accept or reject appointments, facilitator of telecommunication session appointments at the Senior location.

System—technology that enables a three way coordination of a video call, accessed by the Family, Student and Administrator.

Administrator—Employee of the business responsible for maintaining and monitoring appointments, permissions, profiles, availability, site content, site availability, etc.

User—a broad term for the person using the system. Student, Family, Admin all are user types to define the different access levels.

Client—the Family who will create the appointment.

Products—Services offered that define the duration and cost of the appointment.

Jobs—the appointment created by the Family with their Senior and a Student.

FAQs—Frequently Asked Questions.

Facilitator—The Student that brings the tablet to the appointment at the Senior location to facilitate the video call.

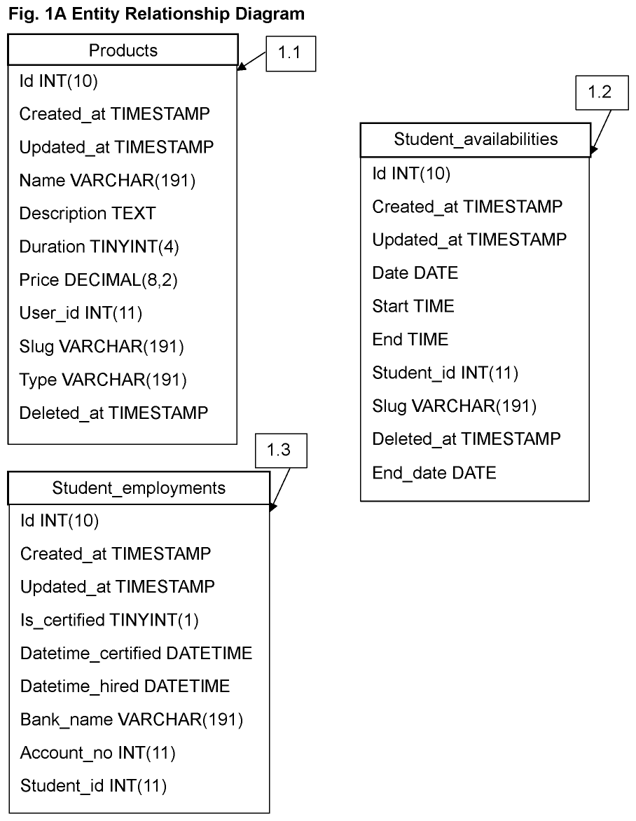

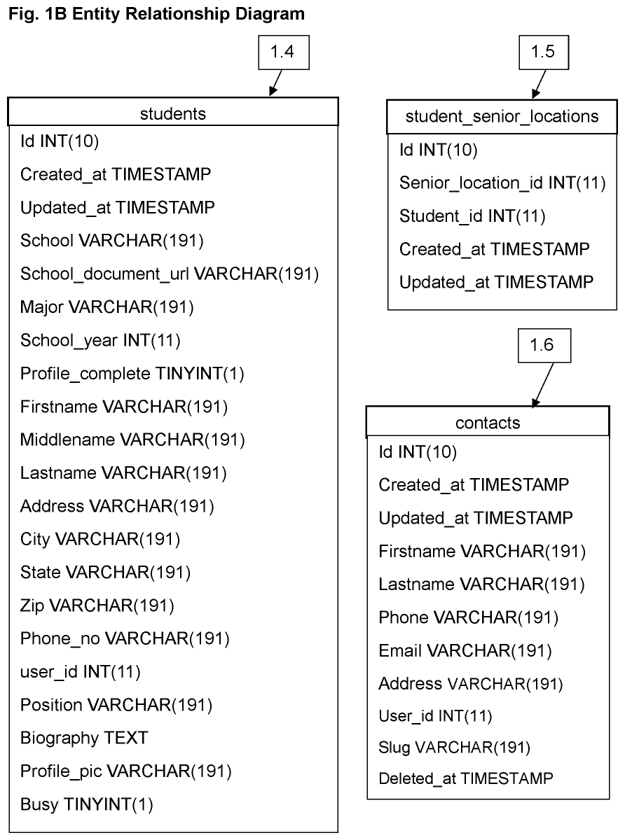

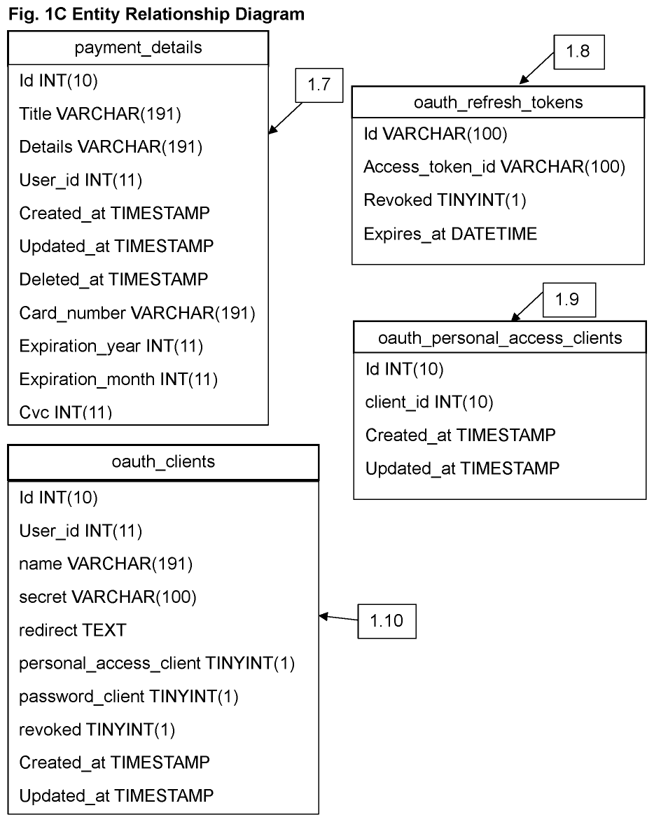

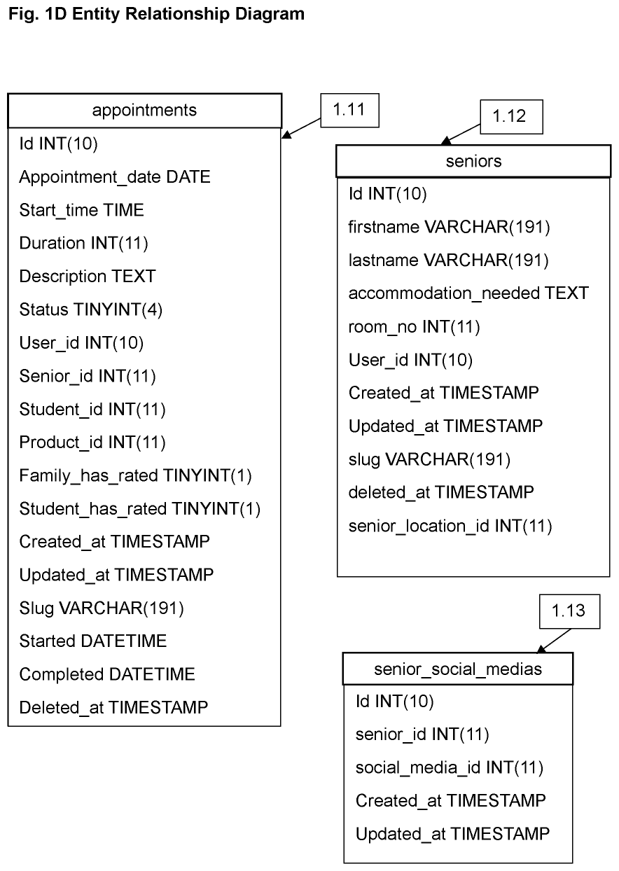

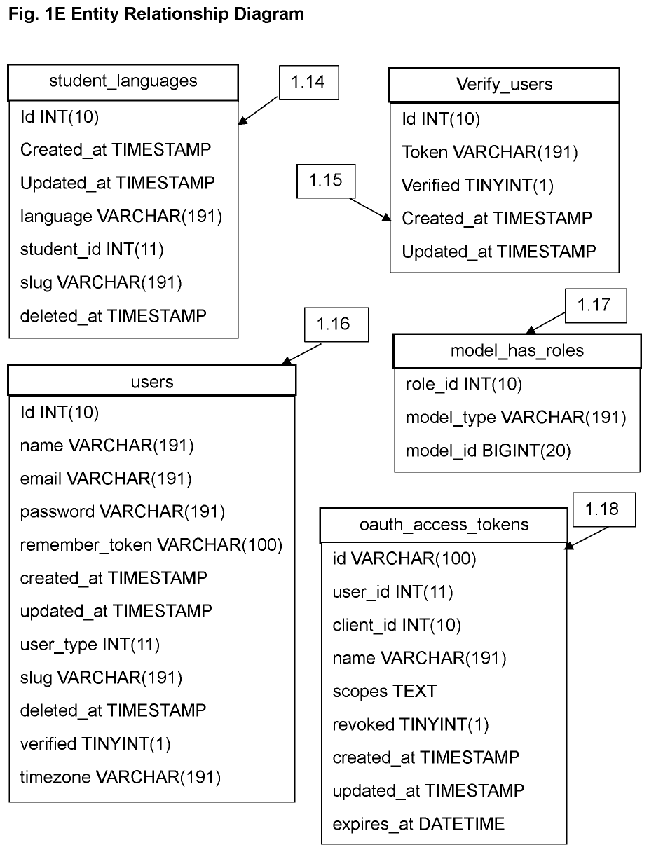

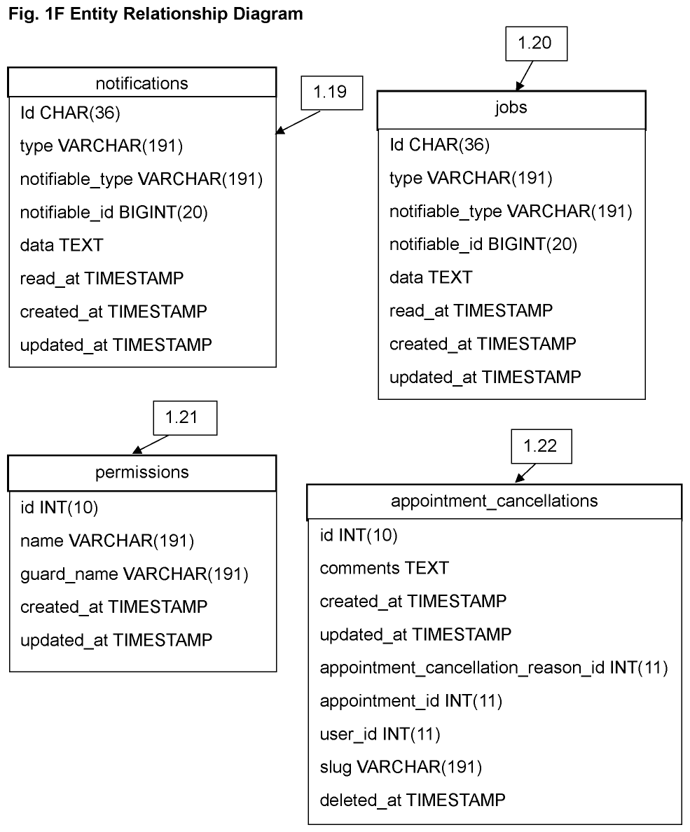

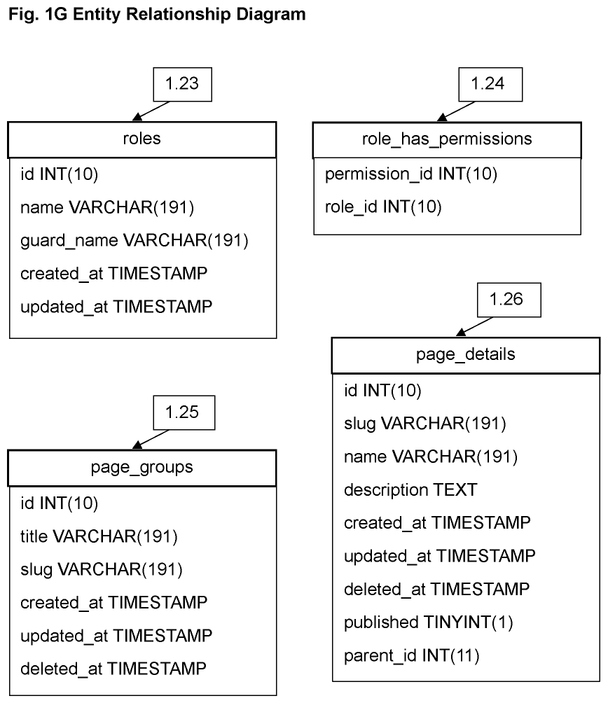

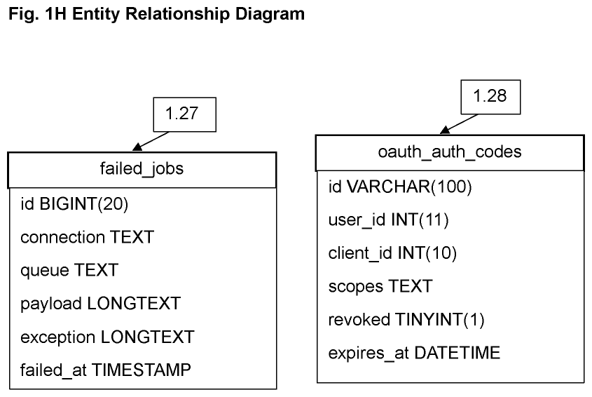

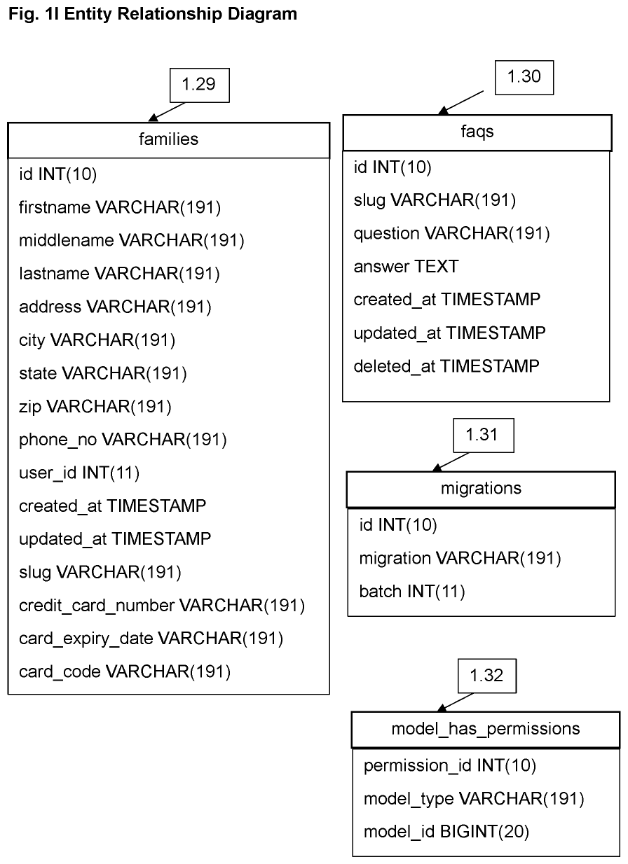

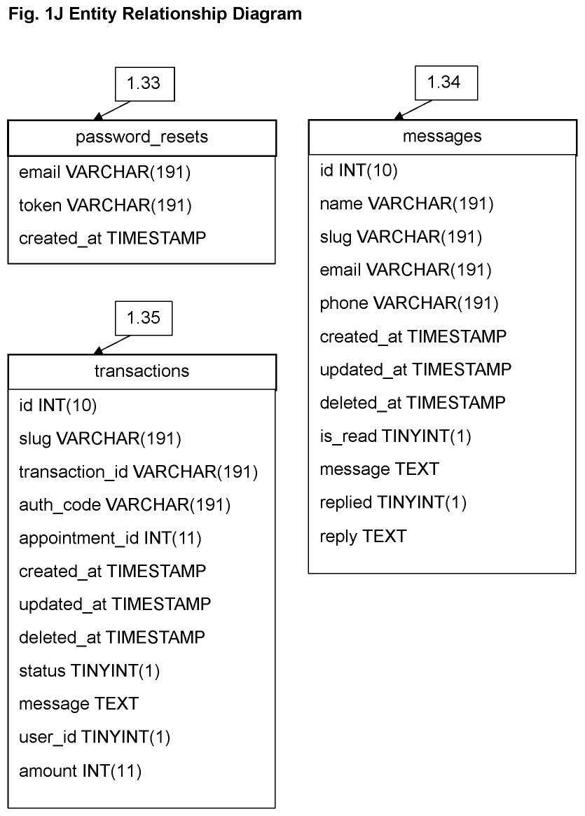

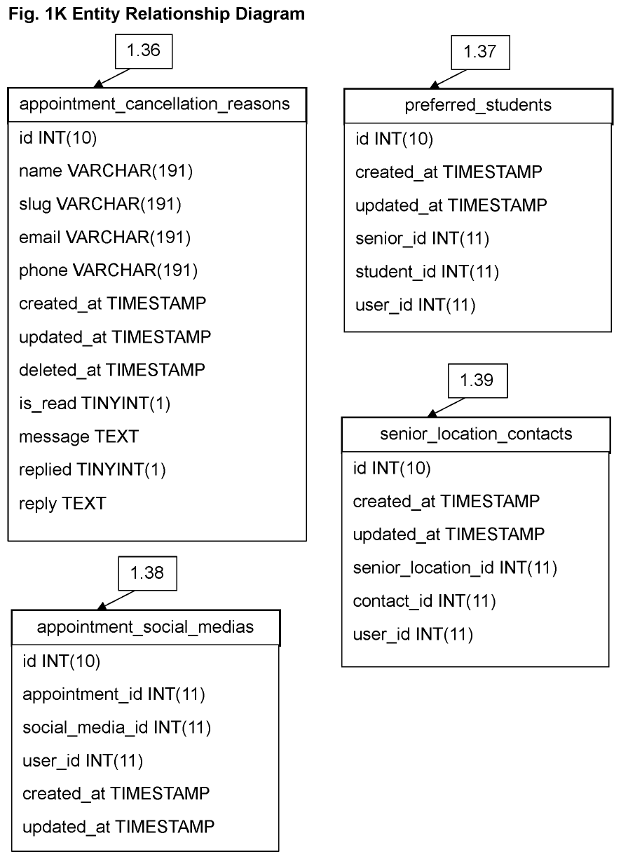

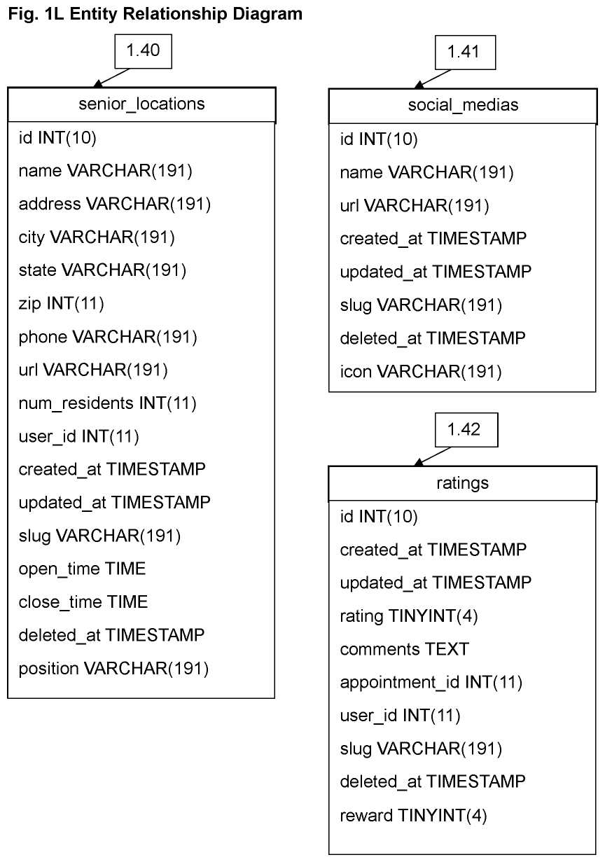

FIG. 1A. Entity Relationship Diagram
1.1 Products database table shows all data elements required to support Products in the system so that the Families can choose the duration and cost of their appointment.
1.2 Student availabilities database table shows data elements required to support the ability for students to enter the date and time they are available to work.
1.3 Student employments database table shows data elements required to support each Student as a unique employee for the business.

FIG. 1B. Entity Relationship Diagram
1.4 Students database table shows data elements required to support the unique characteristics of each Student.
1.5 Student Senior locations database table shows data elements required to support the address of the Senior location so that Students within a 50 mile radius are shown available to the Family creating an appointment.
1.6 Contacts database table shows data elements required to support keeping records on contact detail like phone number, email and other various ways of communication.

FIG. 1C. Entity Relationship Diagram
1.7 Payment details database table shows data elements required to support the ability for the Family to pay for the appointment online through the System to a Payment Processing Vendor.
1.8 Oauth refresh tokens database table shows data elements required to support future use.
1.9 Oauth personal access clients database table shows data elements required to support for future use of mobile applications.
1.10 Oauth clients database table shows data elements required to support future use.

FIG. 1D. Entity Relationship Diagram
1.11 Appointments database table shows data elements required to support the time, date, Senior, Student, Family, location and status of appointment.
1.12 Seniors database table shows data elements required to support data about the Senior.
1.13 Senior social medias database table shows data elements required to support data about the Senior social media preferences.

FIG. 1E. Entity Relationship Diagram
1.14 Student languages database table shows data elements required to support data about the different languages that Student can speak during an appointment.
1.15 Verify users database table shows data elements required to support user verification upon registration.
1.16 Users database table shows data elements required to support all user attributes in order to authorize the user.
1.17 Model has roles database table is a pivot table for table and roles. This table allows access control at the table level.
1.18 Oauth access tokens database table shows data elements required to support future use.

FIG. 1F. Entity Relationship Diagram
1.19 Notifications database table shows data elements required to support notifications for each role in the system.
1.20 Jobs database table shows data elements required to support scheduling jobs and actions like sending email to users if initialization of email does not work.
1.21 Permissions database table shows data elements required to support authorization for user actions like create, delete, etc.
1.22 Appointment cancellations database table shows data elements required to support canceled appointment information and the client reasons entered by the client.

FIG. 1G. Entity Relationship Diagram
1.23 Roles database table shows data elements required to support records of authorization but unlike permissions, it makes sure what users can do on the system like read only.
1.24 Role has permissions database table is the pivot table for roles and permissions that specifies what Families, Students and Administrators can do.
1.25 Page groups database table shows data elements required to support future use to make categories for publishing articles.
FIG. 1.26 Page detail database table shows data elements required to support articles like success stories of Students regarding their appointments.

FIG. 1H. Entity Relationship Diagram
1.27 Failed jobs database table shows data elements required to support failed jobs and attempts to run them again.
1.28 Oauth auth codes database table shows data elements required to support future use.

FIG. 1I. Entity Relationship Diagram
1.29 Families database table shows data elements required to support a profile for the Family role.
1.30 FAQs database table shows data elements required to support frequently asked questions and the answers to them.
1.31 Migrations database table shows data elements required to support records of Laravel tables that have been created.
1.32 Model has permissions database table shows data elements required to support the authorization pivot table that keeps record of which model can do something with the data.

FIG. 1J. Entity Relationship Diagram
1.33 Password resets database table shows data elements required to support password resets.
1.34 Messages database table shows data elements required to support the ability for users to send messages to the administrators and the ability for the administrator to reply.
1.35 Transactions database table shows data elements required to support saved transactions of success or failure for reporting.

FIG. 1K. Entity Relationship Diagram
1.36 Appointment cancellation reasons database table shows data elements required to support reasons why an appointment was canceled.
1.37 Preferred students database table shows data elements required to support saved records of Students who have been appointed on appointments so that this data can be used to suggest to the Family on future appointments.
1.38 Appointment social medias database table shows data elements required to support the social medias the Families wish to be used by the Student during the appointment.
1.39 Senior location contacts database table shows data elements required to support the information about the contacts at the Senior location.

FIG. 1L. Entity Relationship Diagram
1.40 Senior locations database table shows data elements required to support information about the senior location.
1.41 Social medias database table shows data elements required to support saving social media links for the appointment.
1.42 Ratings database table shows data elements required to support the ratings that the Family gives the Student for their performance during an appointment and any reward the Family feels the Student has earned rewarding their performance during the appointment.

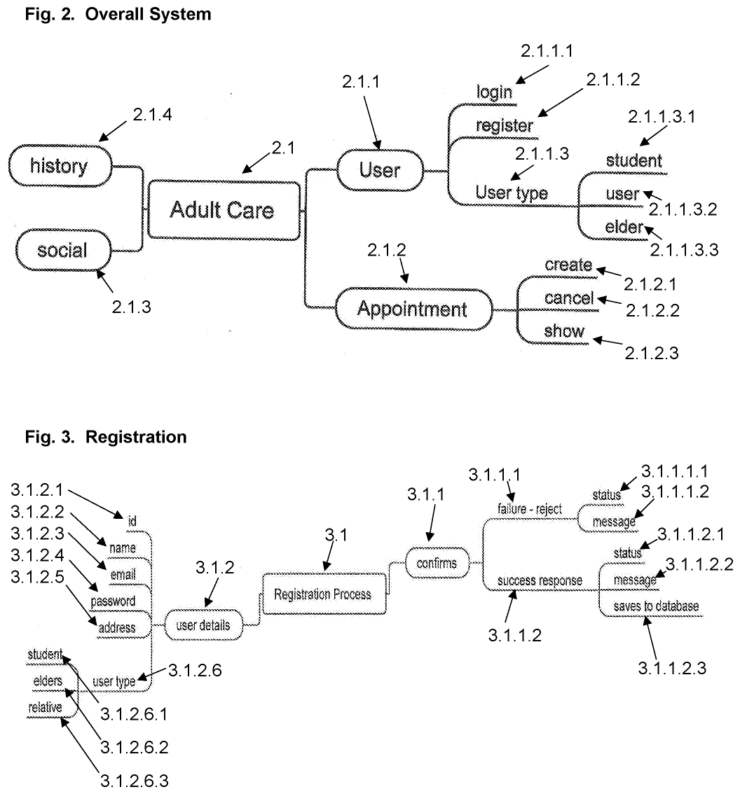

FIG. 2. Overall System
2.1 adult care—the appointment scheduled by the Family to share a video call with their Senior and the Student at the Senior location.
   2.1.1 user—the roles and direct transactions to create and login to their accounts.
      2.1.1.1 login—the act of authenticating and enter the system.
      2.1.1.2 register—the act of creating a user name, password and user type as a user to use the system.
      2.1.1.3 user type—distinguishes the permissions and UI/UX by role.
         2.1.1.3.1 student—facilitator of the appointment with the Senior at the Senior location.
         2.1.1.3.2 user—Family that schedules and pays for the visit.
         2.1.1.3.3 elder—the Senior of the Family at the Senior location.
   2.1.2 appointment—the mechanism to create the three-way match between the Family, Student and Senior at the Senior location.
      2.1.2.1 create—the ability to create the appointment in the system.
      2.1.2.2 cancel—the ability to cancel the appointment.
      2.1.2.3 show—the ability to render the appointment in the UI to the Family, Student and system administrator.
   2.1.3 social—all social media integrated to the system.
   2.1.4 history—is the database of all past transactions and their related data fields.

FIG. 3. Registration
3.1 Registration Process—the overall module of the system that establishes the user by collecting the name, email, chosen password, address and other profile information pertinent to the appointment success. It also returns confirmation of registration success and enables the user to use the system.
   3.1.1 confirms—the component that confirms the registration is successful or fails. When the user enters their name, email, password and user type, and clicks submit, the system will send them an email requesting email account verification. The user must click on the active button in the email to confirm. The API will send the confirmation to the system that the email account is verified. The user has seven (7) days to complete the verification or the registration process fails.
      3.1.1.1 failure—reject—the system did not receive an email confirmation or the email is already being used for an account in the system.
         3.1.1.1.1 status—establish the rejected status of the registration
         3.1.1.1.2 message—email message back to the user notifying them of the rejected registration.
      3.1.1.2 success response—email message to the user that their registration was successful.
         3.1.1.2.1 status—establish the successful status of the registration.
         3.1.1.2.2 message—the email message to the user that the registration was successful.
         3.1.1.2.3 saves to database—the storage of the data.
   3.1.2 user details—the attributes of the user needed to create a user profile, schedule and conduct an appointment and process payment.
      3.1.2.1 id—a unique, system generated number assigned to each user.
      3.1.2.2 name—the first and last name of the user.
      3.1.2.3 email—the user email.
      3.1.2.4 password—the user chosen password.
      3.1.2.5 address—the user address.
      3.1.2.6 user type—the type of user that determines permissions and attributes to create the appointment match.
         3.1.2.6.1 student—the facilitator of the appointment that enters their location and availability in the system.
         3.1.2.6.2 elders—the Senior at the Senior location.
         3.1.2.6.3 relative—the Family that is scheduling the appointment.

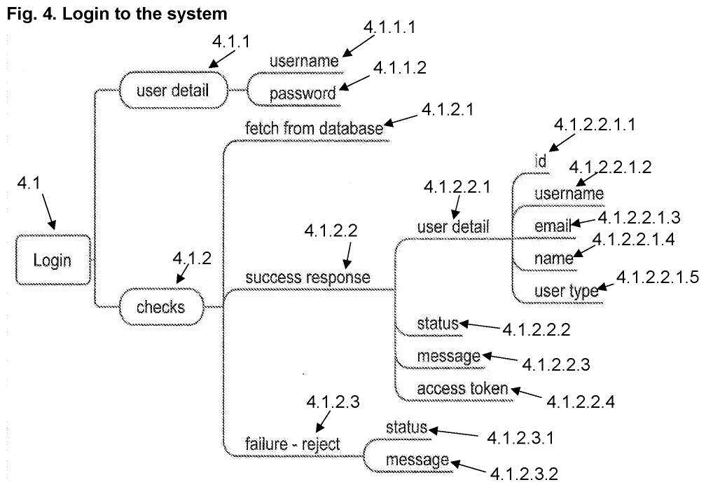

FIG. 4. Login to the system
4.1 Login—object to enable users to log in by verified permissions to use the system.
4.1.1 user detail—store user information.
   4.1.1.1 username—name of user.
   4.1.1.2 password—user chosen password.
4.1.2 checks—system authenticates user.
   4.1.2.1 fetch from database—logs all transactions for login.
   4.1.2.2 success response—successful login.
      4.1.2.2.1 user detail—information about the user.
         4.1.2.2.1.1 id—system generated id number.
         4.1.2.2.1.2 username—username of user.
         4.1.2.2.1.3 email—email of user.
         4.1.2.2.1.4 name—name of user.
         4.1.2.2.1.5 user type—Student or Family or Admin.
      4.1.2.2.2 status—logs successful login attempt.
      4.1.2.2.3 message—displays message to user that login was successful.
      4.1.2.2.4 access token—enables access to the system.
   4.1.2.3 failure—reject—incorrect information, account does not exist.
      4.1.2.3.1 status—logs rejected login attempt.
      4.1.2.3.2 message—displays message to user that login was rejected.

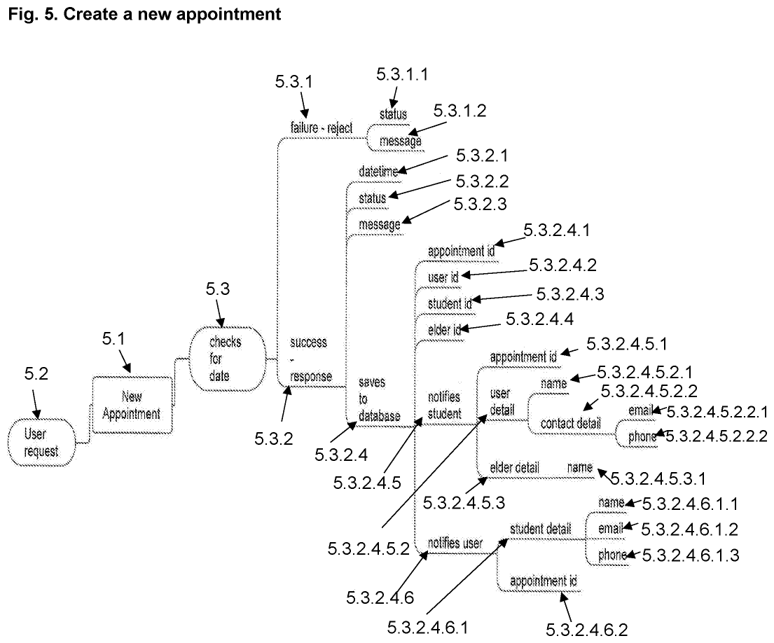

FIG. 5. Create an appointment
5.1 New Appointment—the object that will match, store, notify the Family requested time/date with an available Student in the area of the Senior location.
5.2 User request—is the Family that is requesting a new appointment.
5.3 checks for date—when the Family is creating the appointment, this object will check, notify and store information.
   5.3.1 failure—reject—appointment rejected for reason such as Senior already booked for another appointment.
      5.3.1.1 status—logs a reject status.
      5.3.1.2 message—sends a message to the user that the appointment date/time is not available.
   5.3.2 success—response—appointment is successful.
      5.3.2.1 datetime—logs the date and time of the appointment created.
      5.3.2.2 status—logs successful appointment creation.
      5.3.2.3 message—returns message to the user that the appointment is created. Displays message in the system that the appointment is pending confirmation from the Student.
      5.3.2.4 saves to database—stores information about the appointment.
         5.3.2.4.1 appointment id—the system generated number that is unique to the appointment.
         5.3.2.4.2 user id—Family ID number.
         5.3.2.4.3 student id—Student ID number.
         5.3.2.4.4 elder id—Senior ID number.
         5.3.2.4.5 notifies student—system notifies Student that an appointment has been created by a Family and is waiting for the Student to confirm they will take the appointment.
         5.3.2.4.5.1 appointment id—the system generated number that is unique to the appointment.
         5.3.2.4.5.2 userdetail—information about the Family that has created the appointment.
         5.3.2.4.5.2.1 name—Family name.
         5.3.2.4.5.2.2 contact detail—Family contact information.
         5.3.2.4.5.2.2.1 email—Family email.
         5.3.2.4.5.2.2.2 phone—Family phone number.
         5.3.2.4.5.3 elder detail—Senior name and location.
         5.3.2.4.5.3.1 name—Senior name.
         5.3.2.4.6 notifies user—System notifies the Family.
         5.3.2.4.6.1 student detail—information about the Student that will be taking the appointment.
         5.3.2.4.6.1.1 name—name of the Student.
         5.3.2.4.6.1.2 email—email of the Student.
         5.3.2.4.6.1.3 phone—phone number of the Student.
         5.3.2.4.6.2 appointment id—the system generated number that is unique to the appointment.

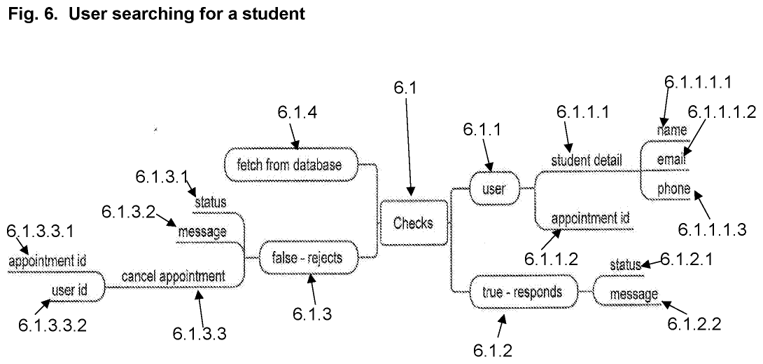

FIG. 6. User searching for a student
6.1 checks—the function to check the availability of Students to take the appointment they created.
   6.1.1 user—the Family.
      6.1.1.1 student detail—information about the Student.
         6.1.1.1.1 name—name of the Student.
         6.1.1.1.2 email—email of the Student.
         6.1.1.1.3 phone—phone number of the Student.
      6.1.1.2 appointment id—the system generated number that is unique to the appointment.
   6.1.2 true—responds—the system has matched the Student availability with the created appointment.
      6.1.2.1 status—is true the match is made.
      6.1.2.2 message—returns Student name to the Family as being available during the created appointment.
   6.1.3 false—rejects—requested Student is not available.
      6.1.3.1 status—the Student is not available.
      6.1.3.2 message—system notifies the Family user that the requested Student is not available.
      6.1.3.3 cancel appointment—Family cancels appointment.
         6.1.3.3.1 appointment id—the system generated number that is unique to the appointment.
         6.1.3.3.2 user id—Family ID number.
   6.1.4 database—stores information about the Student and their availability to take appointments that they have entered in the system.

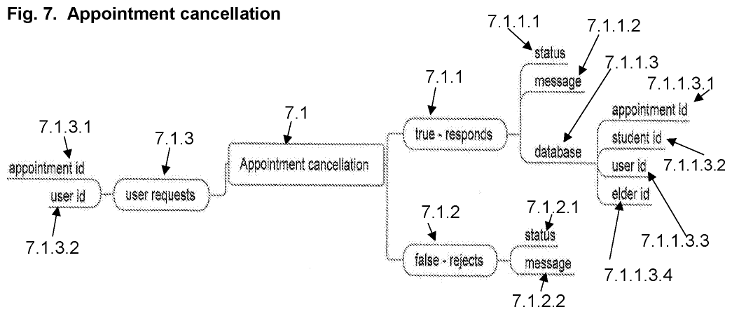

FIG. 7. Appointment cancellation
7.1 Appointment cancellation—Family cancels appointment.
   7.1.1 true—responds—system accepts cancellation.
      7.1.1.1 status—cancellation confirmed.
      7.1.1.2 message—returns message to the user.
      7.1.1.3 database—logs cancellation.
         7.1.1.3.1 appointment ID—the system generated number that is unique to the appointment.
         7.1.1.3.2 student ID—Student ID number.
         7.1.1.3.3 user ID—Family ID number.
         7.1.1.3.4 elder ID—Senior ID number.
   7.1.2 false—rejects—system rejects request to cancel appointment.
      7.1.2.1 status—logs rejection.
      7.1.2.2 message—returns message to the user.
   7.1.3 user requests—the Family requests a cancellation.
      7.1.3.1 appointment ID—the system generated number that is unique to the appointment.
      7.1.3.2 user ID—Family ID number.

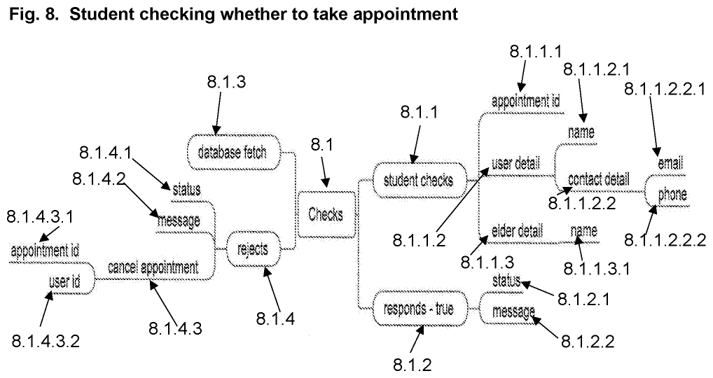

FIG. 8. Student checking whether to take appointment
8.1 checks—system enables the Student to check the details of the appointment and decide whether to accept or decline.
   8.1.1 student checks—the facilitator of the appointment that enters their location and availability in the system.
      8.1.1.1 appointment ID—the system generated number that is unique to the appointment.
      8.1.1.2 user detail—information about the Family.
         8.1.1.2.1 name—name of Family.
         8.1.1.2.2 contact detail—contact information of the Family.
         8.1.1.2.2.1 email—Family email.
         8.1.1.2.2.2 phone—Family phone number.
      8.1.1.3 elder detail—Senior name and location.
         8.1.1.3.1 name—Senior name.
   8.1.2 responds—true—Student accepts the appointment created by the Family.
      8.1.2.1 status—appointment is confirmed.
      8.1.2.2 message—email triggered to Family and Student confirming appointment.
   8.1.3 database fetch—stores information about the appointment.
   8.1.4 rejects—Student does not accept appointment.
      8.1.4.1 status—Student declines appointment status and system is updated.
      8.1.4.2 message—triggers email to Family that appointment is declined.
      8.1.4.3 cancel appointment—Family cancels appointment.
         8.1.4.3.1 appointment ID—the system generated number that is unique to the appointment.
         8.1.4.3.2 user id—Family ID.

Technologies Used

As its 2018/19 system, there is best practice of separating frontend and backend.

Frontend: HTML, SCSS, Vue.js, jQuery. Frontend is responsible for handling all the look and feel that allows us to request and display data as most pleasing as possible. All the user interactions like form filling, report generation and so on is handled from the frontend. But, the frontend won't be responsible for the interaction with the database.

Backend: PHP Laravel, MYSQL. Backend is responsible for handling database and user information. Backen is responsible for saving, fetching, calculating and so on.

HTML: “HTML or Hypertext Markup Language, is used to create web pages. Site authors use HTML to format text as titles and headings, to arrange graphics on a webpage, to link to different pages within a website, and to link to different websites.”—draac.com

CSS: “CSS is the language for describing the presentation of Web pages, including colors, layout, and fonts. It allows one to adapt the presentation to different types of devices, such as large screens, small screens, or printers. CSS is independent of HTML and can be used with any XML-based markup language.”—w3.org

SCSS: “One of the great benefits of using a CSS pre-processor like SCSS is the ability to use variables. A variable allows you to store a value or a set of values, and to reuse these variables throughout your SCSS files as many times you want and wherever you want. Easy, powerful, and useful.”—mugo.ca

Vue.js: “Vue (pronounced /vju:/, like view) is a progressive framework for building user interfaces. Unlike other monolithic frameworks, Vue is designed from the ground up to be incrementally adoptable. The core library is focused on the view layer only, and is easy to pick up and integrate with other libraries or existing projects. On the other hand, Vue is also perfectly capable of powering sophisticated Single-Page Applications when used in combination with modern tooling and supporting libraries.”—vuejs.org

The invention claimed is:

1: A method for coordination of at least three individuals for a telecommunications session, the method including the steps of:
gathering information about Senior individual, including location of the Senior individual;
inputting information related to a remote individual, including at least one time for a telecommunications session between the remote individual and the Senior individual;
identifying at least one available facilitator individual based at least partially on a proximity of the facilitator individual to the Senior individual;
matching the remote individual with the facilitator individual and the Senior individual for a telecommunication session time and telecommunication session location, with the time being acceptable to the remote individual and facilitator individual and with the location being acceptable to the facilitator individual matching the location of the Senior individual; and
scheduling and conducting a telecommunication session with the facilitator individual and Senior individual together at the location of the Senior individual, with the telecommunication session also occurring with the individual at the remote location, and with the facilitator individual maintaining effective operation of a telecommunications tool, for facilitation of a telecommunication session through the telecommunications tool between the Senior individual and the remote individual.
